(19) United States
(12) Patent Application Publication
(10) Pub. No.: US 2022/0343146 A1
(43) Pub. Date: Oct. 27, 2022

(54) METHOD AND SYSTEM FOR TEMPORAL GRAPH NEURAL NETWORK ACCELERATION

(71) Applicant: Alibaba Singapore Holding Private Limited, Singapore (SG)

(72) Inventors: Fei XUE, Sunnyvale, CA (US); Yangjie ZHOU, Shanghai (CN); Hongzhong ZHENG, Los Gatos, CA (US)

(21) Appl. No.: 17/238,620

(22) Filed: Apr. 23, 2021

(51) Int. Cl. G06N 3/063; G06N 3/04

(52) U.S. Cl. CPC G06N 3/063; G06N 3/0454; G06N 3/0445

(57) ABSTRACT

This application describes a hardware accelerator, a computer system and a method for accelerating temporal graphic neural networks computations. An exemplary hardware accelerator comprises: a key-graph memory configured to store a key graph; a nodes classification circuit configured to: fetch the key graph from the key-graph memory; receive a current graph for performing temporal GNN computation with the key graph; and identify one or more nodes of the current graph based on a comparison between the key graph and the current graph; and a nodes reconstruction circuit configured to: perform spatial computations on the one or more nodes identified by the node classification circuit to obtain updated nodes; generate an updated key graph based on the key graph and the updated nodes; and store the updated key graph in the key-graph memory for processing a next graph.

### TECHNICAL FIELD

The disclosure relates generally to accelerating temporal graph neural networks (GNNs). More specifically, this disclosure is related to a method and system for accelerating the performance and energy efficiency of temporal GNNs through a hardware software co-design.

### BACKGROUND

While traditional deep learning models are good at pattern recognition and data mining by capturing hidden patterns of Euclidean data (e.g., images, text, videos), Graph neural networks (GNNs) have shown to extend the power of machine learning to non-Euclidean domains represented as graphs with complex relationships and interdependencies between objects. Research has shown that GNNs can exceed state-of-the-art performance on applications ranging from molecular inference to community detection.

Temporal GNN is a new type of GNN that has been widely applied to a variety of practical applications involving spatial-temporal data processing, such as traffic flow prediction, weather forecast, skeleton-based action recognition, video understanding, etc. Temporal GNNs extend static graph structures with temporal connections and then apply traditional GNNs to the extended graphs. This application describes a novel way to improve the performance and energy efficiency of temporal GNNs.

### SUMMARY

Various embodiments of the present specification may include systems, methods, and non-transitory computer-readable media for accelerating temporal GNNs.

According to one aspect, a hardware accelerator for accelerating temporal graphic neural network (GNN) computations is described. The hardware accelerator may include a key-graph memory configured to store a key graph; a nodes classification circuit configured to: fetch the key graph from the key-graph memory; receive a current graph for performing temporal GNN computation with the key graph; and identify one or more nodes of the current graph based on a comparison between the key graph and the current graph; and a nodes reconstruction circuit configured to: perform spatial computations on the one or more nodes identified by the node classification circuit to obtain updated nodes; generate an updated key graph based on the key graph and the updated nodes; and store the updated key graph in the key-graph memory for processing a next graph.

In some embodiments, to identify the one or more nodes of the current graph, the nodes classification circuit is configured to: for each node in the current graph, identify a corresponding node in the key graph; determine a distance between a first feature vector of the node in the current graph and a second feature vector of the corresponding node in the key graph; and select the node if the distance is greater than a threshold.

In some embodiments, the distance is a Hamming distance.

In some embodiments, to determine the distance between the first feature vector of the node in the current graph and the second feature vector of the corresponding node in the key graph, the nodes classification circuit is configured to: determine a unit of bits to be compared between the first feature vector and the second feature vector based on a type of data within the first feature vector and the second feature vector; for each unit of bits within the first feature vector, compare exponent bits and one or more fraction bits within the each unit of bits against corresponding bits within the second feature vector to obtain a number of matching bits; and determine the distance between the first feature vector and the second feature vector based on the number of matching bits.

In some embodiments, the nodes classification circuit is further configured to: in response to the key graph received from the key-graph memory being empty, sending the received current graph to the nodes reconstruction circuit; and wherein the nodes reconstruction circuit is further configured to: perform spatial computations on each node in the current graph to obtain a new key graph, wherein the spatial computations comprise GNN computations; and send the new key graph to the key-graph memory for storing.

In some embodiments, to perform the spatial computations on the one or more identified nodes, the nodes reconstruction circuit is further configured to: obtain a feature vector of one node from the one or more identified nodes and an adjacency matrix of the current graph; identify one or more neighboring nodes based on the adjacency matrix; recursively aggregate and transform feature vectors of the one or more neighboring nodes and the feature vector of the node to obtain the updated feature vector of the node.

In some embodiments, the hardware accelerator may further include a temporal computation circuit configured to perform temporal computations based on the key graph and the updated key graph.

In some embodiments, the temporal computations comprise: determining temporal features between the key graph and the updated key graph with a convolutional neural network (CNN).

In some embodiments, the temporal computations comprise: determining temporal features between the key graph and the updated key graph with a Long Short-Term Memory (LSTM) neural network.

In some embodiments, to generate the updated key graph based on the key graph and the updated nodes, the nodes reconstruction circuit is configured to: identify, in the key graph, one or more first nodes that correspond to the one or more updated nodes; and generate the updated key graph by replacing feature vectors of the one or more first nodes in the key graph with feature vectors of the one or more updated nodes.

According to other embodiments, a system comprises one or more processors and one or more computer-readable memories coupled to the one or more processors and having instructions stored thereon that are executable by the one or more processors to perform the method of any of the preceding embodiments.

According to yet other embodiments, a non-transitory computer-readable storage medium is configured with instructions executable by one or more processors to cause the one or more processors to perform the method of any of the preceding embodiments.

According to yet other embodiments, a computer system for accelerating temporal graph neural network (Temporal GNN) computations is described. The computer system comprises a first memory configured to store a key graph; a second memory configured to store a current graph for temporal GNN computation; receiving circuitry configured to receive the key graph from the first memory and the current graph from the second memory; identifying circuitry configured to identify one or more nodes of the current graph based on a comparison between the key graph and the current graph; computing circuitry configured to perform spatial computations on the one or more identified nodes to obtain updated nodes; and updating circuitry configured to generate an updated key graph based on the key graph and the updated nodes for the first memory to store the updated key graph for the temporal GNN computation.

Embodiments disclosed in the specification have a variety of technical effects. As briefly mentioned in the background section, temporal GNNs usually work on data collected from a number of continuous timesteps, such as a video of traffic flow data. This data may be highly redundant as the versions collected from adjacent time steps may not be significantly changed. When performing temporal GNN computations, storing redundant data may lead to additional storage overhead, and performing calculation on these redundant data may result in poor performance and energy consumption spikes. In some embodiments described herein, this data redundancy is exploited to effectively reduce the volume of data to be processed in temporal GNNs. For example, assuming the data collected from a number of time steps are represented as a series of graphs (i.e., a data structure), one of the graphs may be identified as a key graph and the other graphs may be identified as secondary graphs. All nodes in the key graph may go through the spatial computations using a traditional GNN to obtain an updated key graph. For a secondary graph, only a subset of nodes in the secondary graph may need to go through the spatial computations (to avoid the redundant computations on the nodes that are similar to the ones in the key graph) to obtain corresponding updated nodes. The other nodes in the secondary graph may skip the spatial computations using the traditional GNN. These updated nodes may be merged into the key graph to obtain the updated key graph. The updated key graph may then be used as the new key graph for processing the next incoming input graph. In some embodiments, the subset of nodes may be determined by a comparison of the key graph and the secondary graph. For example, if a distance between a node in the secondary graph and a corresponding node in the key graph is greater than a threshold, the node may be selected into the subset. Afterward, the different versions of key graphs (e.g., two key graphs from two adjacent time steps) may go through temporal computations to explore the temporal features in the data. These temporal features may then be used to make predictions for future time steps (e.g., predicting key graphs for future time steps). In comparison with existing temporal GNN designs in which all nodes in each graph (data collected from each time step) have to go through the spatial and temporal computations, the above-described embodiments significantly reduce the amount of data to be processed for all secondary graphs, which lead to improved performance and optimized energy efficiency for temporal GNN computations. In some embodiments, the skipped nodes in the secondary graph may be restrained from sending to the processors for caching (e.g., in on-chip memories or caches), thereby saving the storage footprint of the temporal GNN in the cache/memory spaces in the processors.

These and other features of the systems, methods, and non-transitory computer-readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, where like reference numerals designate corresponding parts in the various figures. It is to be expressly understood, however, that the drawings are for purposes of illustration and description only and are not intended as a definition of the limits of the invention.

### BRIEF DESCRIPTION OF THE DRAWINGS

FIG. 1 illustrates a schematic diagram of an exemplary hardware environment for implementing embodiments and features of the present disclosure.

FIG. 2 illustrates a schematic diagram of a hardware device for implementing temporal graph neural network (GNN) accelerators in accordance with some embodiments.

FIG. 3 illustrates an exemplary framework of a temporal GNN in accordance with some embodiments.

FIG. 4 illustrates an exemplary workflow for accelerating temporal GNN computations with deduplication in accordance with some embodiments.

FIG. 5 illustrates an internal structure diagram of a temporal GNN accelerator in accordance with some embodiments.

FIG. 6 illustrates an exemplary method for accelerating temporal GNN preprocessing in accordance with some embodiments.

FIG. 7 illustrates a block diagram of a computer system apparatus for accelerating temporal GNN in accordance with some embodiments.

### DETAILED DESCRIPTION

The specification is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present specification. Thus, the specification is not limited to the embodiments shown but is to be accorded the widest scope consistent with the principles and features disclosed herein.

Graph Neural Network (GNN) has gained increasing popularity in various domains, including social networks, knowledge graphs, recommender systems, and even life science. At a high level, GNN involves computation on a graph structure G=(V, E) representing a graph (undirected or directed), where V denotes vertices and E denotes edges. In some embodiments, each of the nodes in the graph may be associated with a plurality of features. The graph may have different practical meanings depending on the use cases. For example, a GNN may be applied to mine the features of users on a social media network and/or learn the relationships among the users. As another example, nano-scale molecules have an inherent graph-like structure with the ions or the atoms being the nodes and the bonds between them, edges. GNNs can be applied in both scenarios: learning about existing molecular structures as well as discovering new chemical structures.

Temporal GNN is an extension of GNN with an additional time dimension for handling use cases in which the graph representation of data evolves with time, such as traffic flow prediction, video understanding, skeleton-based action recognition, etc. A social network may be a good illustration for dynamic graphs: when a user joins the platform, a new vertex is created. When the user follows another user, an edge is created. When the user changes its profile, the vertex is updated. In general, a temporal GNN may involve computations on a graph structure G=(V, E, T), where V denotes vertices, E denotes edges, and T denotes the time dimension. Existing temporal GNNs perform the traditional GNN computations (e.g., mining features) on each graph representation of data collected from each time step. The GNN computations involve recursively aggregating and transforming feature vectors of the nodes in the graph, which are both computing-intensive and memory-intensive. Furthermore, in practical applications, the graphs are usually massive in volume (e.g., a graph representing millions of users on a social network and their interactions), which makes the existing temporal GNNs unsuitable for time-sensitive use cases, such as making real-time or near real-time predictions. To address this issue, this disclosure describes a novel method to improve the performance of temporal GNNs by reducing redundant computations.

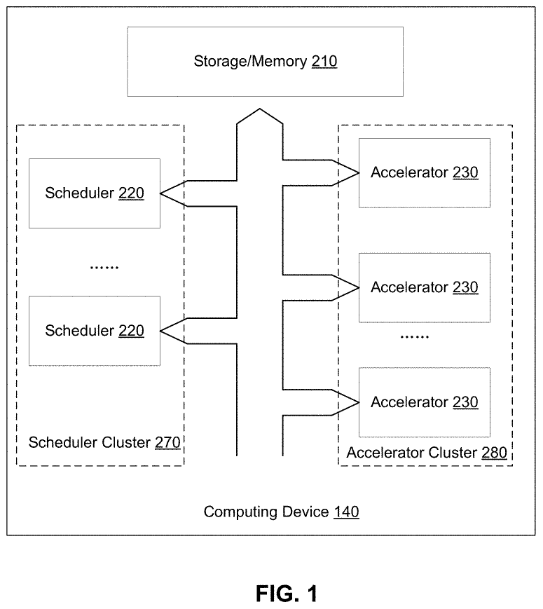

FIG. 1 illustrates a schematic diagram of an exemplary hardware environment for implementing embodiments and features of the present disclosure. The hardware environment in FIG. 1 includes a computing device 140 for illustrative purposes. Depending on the implementation, the computing device 140 may include fewer, more, or alternative components.

As shown, the computing device 140 includes a storage/memory 210 component connected to a scheduler cluster 270 and an accelerator cluster 280. The scheduler cluster 270 may contain multiple scheduler 220 and the accelerator cluster 280 may contain multiple accelerators 230. In some embodiments, the accelerator 230 may refer to a special processing unit designed to accelerate the processing speed of the neural network model at different stages (e.g., input data preprocessing, convolution operations, pooling operations, etc.). The accelerator may be embodied as a graphics processing unit (GPU), application-specific integrated circuit (ASIC), or field programmable gate array (FPGA), etc. to implement the logics for accelerating neural network operations. The scheduler 220 may refer to a processing unit that determines the scheduling of the accelerators 230, and distributes instructions and/or data to be executed to each accelerator 230. In some embodiments, the scheduler 220 may be implemented as Central Processing Unit (CPU), application-specific integrated circuit (ASIC), field programmable gate array (FPGA), or other suitable forms.

In comparison, the traditional CPU architecture allocates its majority of resources to the control unit and storage unit, while the computing unit is often under-resourced. While CPU is very effective in the logical control aspect, it is not efficient in the large-scale parallel computing. Therefore, various hardware accelerators have been developed to improve the processing speed of computation for different functions and different fields. The hardware accelerator proposed in the present specification includes a processing unit dedicated to accelerating the performance of GNN computations. It is a data-driven parallel computing architecture dealing with a large volume of operations, such as graph partitioning, row/column reordering, hardware-granularity-aware matrix partitioning, convolution, pooling, another suitable operation, or any combination thereof. The data and intermediate results of these operations may be closely related to each other in the whole GNN process, and will be frequently used. Without the accelerators, the existing CPU framework with small memory capacities in the core of the CPU will lead to a large number of frequent memory accesses to the outside storage/memory (e.g., outside of the CPU). These memory accesses are costly and will cause low processing efficiency. With the accelerators, which is dedicated to accelerating the data processing speed of GNNs, can greatly improve the processing efficiency and computing performance for at least following reasons: (1) the input data (graph) may be partitioned into a plurality of sub-matrices to cluster similar nodes (with similar feature vectors), (2) the rows and columns of each sub-matrix may be reordered to cluster data with similar levels of sparsity, and (3) each sub-matrix may be further partitioned into smaller units called tiles based on data processing granularities of the underlying processors performing the GNN computations (convolution, aggregation, transformation, polling, etc.). Since the tiles are carefully sized to fit underlying processors, the on-chip memory in each processor may be utilized in the GNN computations and frequent memory access to the off-chip memory may be avoided.

In some embodiments, the storage/memory 210 may store various neural network models (e.g., the nodes of these models and the weight or parameters of these nodes) and input data to these models (e.g., input graphs to GNNs, such as nodes, feature vectors of the nodes, edges, etc.). The accelerator 230 in this specification may perform preprocessing of the input data to the models to accelerate the subsequent neural network computations. For example, a scheduler 220 may send the address of an input graph within the storage/memory 210 to an accelerator 230 in the form of instructions. The accelerator may subsequently (e.g., at a scheduled point in time) locate and fetch the input data directly from the storage/memory 210 and temporarily store them in its on-chip memory for preprocessing the input data. The output of the preprocessing may include a plurality of tiles of data with different levels of sparsity. In some embodiments, these tiles may be distributed to a plurality of underlying processors for accelerated computation. Different underlying processors may be optimized to perform neural network computations on data sets with different levels of sparsity. Distributing the tiles to the underlying processors may include assigning each tile to one underlying processor optimized to process data sets with the sparsity level of the data set in the each tile. The outputs of the underlying processors may be aggregated to generate the final computation result. In some embodiments, these underlying processors may be implemented as a part of or separately from the accelerator 230. If the underlying processors are implemented as part of the accelerators 230, the schedulers 220 may send the addresses of the parameters of the corresponding neural network model in storage/memory 210 to the accelerator 230 in the form of instructions. The accelerator 230 may subsequently locate these parameters (such as weights) directly in storage/memory 210 and temporarily store them in its on-chip memory for the underlying processors to perform the computations based on the above-mentioned tiles.

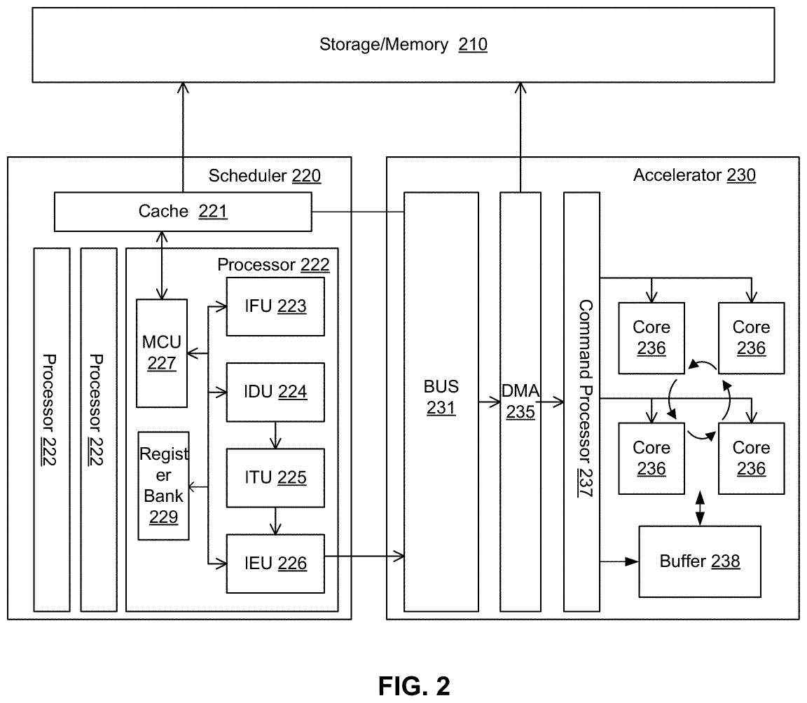

FIG. 2 illustrates a schematic diagram of a hardware device for implementing hardware accelerators in accordance with some embodiments. The hardware device in FIG. 2 illustrates the internal structures of a scheduler 220 and an accelerator 230 in FIG. 1, as well as the data/instruction flow among the scheduler 220, the accelerator 230, and the storage/memory 210.

As shown in FIG. 2, the scheduler 220 may include multiple processor 222 and a cache 221 shared by the multiple processors 222. Each processor 222 may include an instruction fetching unit (IFU) 203, an instruction decoding unit (IDU) 224, an instruction transmitting unit (ITU) 225, and an instruction execution unit (IEU) 226.

In some embodiments, the IFU 223 may fetch to-be-executed instructions or data from the storage/memory 210 to an register bank 229. After obtaining the instructions or data, the scheduler 220 enters an instruction decoding stage. The IDU 224 decodes the obtained instruction according to a predetermined instruction format to determine operand(s) acquisition information, where the operands are required to execute the obtained instruction. In some embodiments, the operand(s) acquisition information may include pointers or addresses of immediate data, registers, or other software/hardware that provide the operand(s).

In some embodiments, the ITU 225 may be configured between the IDU 224 and the IEU 226 for instruction scheduling and management. It may efficiently allocate instructions to different IEUs 226 for parallel processing.

In some embodiments, after the ITU 225 allocates an instruction to one IEU 226, the IEU 226 may execute the instruction. However, if the IEU 226 determines that the instruction should be executed by the accelerator 230, it may forward the instruction to the corresponding accelerator 230 for execution. For example, if the instruction is directed to GNN computation based on an input graph, the IEU 226 may send the instruction to the accelerator 230 via the bus 231 for the accelerator 230 to execute the instruction.

In some embodiments, the accelerator 230 may include multiple cores 236 (4 cores are shown in FIG. 2, but those skilled in the art may appreciate that the accelerator 230 may also include other numbers of cores 236), a command processor 237, and direct storage access (DMA) interface 235, and bus channel 231.

The bus channel 231 may include a channel through which instructions/data enter and exit the accelerator 230. The DMA interface 235 may refer to a function provided by some computer bus architectures, which enables devices to directly read data from and/or write data to the memory 210. Compared with the method in which all data transmission between devices passes through the scheduler 220, the architecture illustrated in FIG. 2 greatly improves the efficiency of data access. For instance, the core of the accelerator 230 may directly access the memory 210 and read the parameters of a neural network model (for example, the weight of each node) and/or input data.

The command processor 237 may be configured to allocate the instructions sent by the scheduler 220 via the IEU 226 to the accelerator 230 to the cores 236 for execution. After the to-be-executed instructions enter the accelerator 230 from the bus channel 231, they may be cached in the command processor 237, and the command processor 237 may select the cores 236 and allocates the instructions to the cores 236 for execution. In addition, the command processor 237 may be also responsible for the synchronization operation among the cores 236.

In some embodiments, the instruction allocated by the command processor 237 may include preprocessing an input graph for accelerating GNN computations. The instruction may be sent to a graph preprocessing core 238 to perform the preprocessing. In some embodiments, the input graph may be directly located and fetched from the storage/memory 210 through the DMA interface 235. In some embodiments, the input graph may be represented as an adjacency matrix. Each node in the input graph may correspond to a row and a column in the adjacency matrix, and the features of each node may be represented as a feature vector in the adjacency matrix.

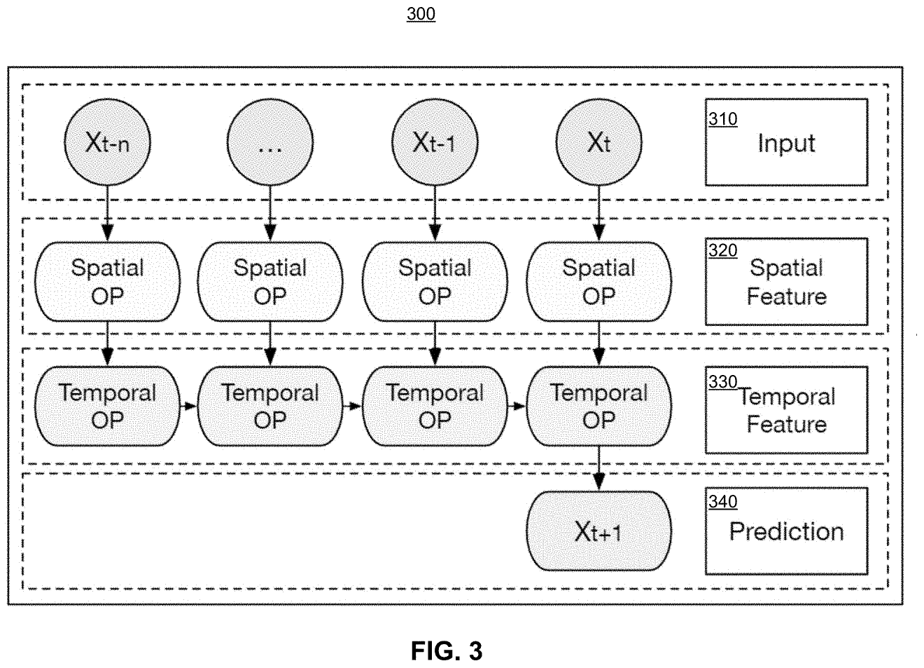

FIG. 3 illustrates an exemplary framework 300 of a temporal graphic neural network (GNN) in accordance with some embodiments. The framework illustrated in FIG. 3 depicts a generalized workflow of a temporal GNN. Depending on the implementation and use cases, the temporal GNN may have more, fewer, or alternative layers or components.

The temporal GNN in the framework 300 may be trained to make predictions 340 based on input data 310. The input data 310 and the predictions 340 may have various practical meanings depend on the actual use case. For example, the input data 310 may include a video recording of traffic flows. The video may be collected from one or more cameras for traffic monitoring at one or more intersections. In this context, the predictions 340 may include future traffic conditions predicted based on the spatial features 320 and temporal features 330 learned from the input data 110.

In some embodiments, the input data 310 may include a plurality of sets of input data collected across a plurality of timesteps. Each set of input data may be represented as a graph with vertices (denoting objects) and edges (denoting relationships among the objects). In the context of traffic flow prediction, each set of input data may include a “snapshot” of the traffic condition at the one or more intersections at one timestep. Assuming the current time is t, the traffic data collected from previous n timesteps may be respectively represented as n graphs, denoted as Xₜ₋ₙ, . . . , Xₜ₋₁, Xₜ in FIG. 3.

Each of the n graphs may include a plurality of spatial features 320 among the vertices and edges. In some embodiments, these spatial features 320 may be explored by using GNNs. For example, one input graph may include a plurality of vertices with initial feature vectors. The initial feature vector of a vertex may include feature values of the vertex. For example, in a social network setting, each user may be represented as a node, and the user's features (profile information, current status, recent activities, etc.) may be represented as a feature vector. After performing GNN computations on the input graph, an updated graph may be generated and include the plurality of nodes with updated feature vectors. The updated feature vectors may embed the features from neighboring nodes. The GNN computations may follow a neighborhood aggregation scheme, where the feature vector of a vertex is computed by recursively aggregating and transforming feature vectors of its neighboring nodes.

After the spatial features 320 in each of the plurality of graphs are learned, one or more updated graphs may be generated. Temporal features 330 may be explored by performing temporal computations on each of the updated graphs. In some embodiments, the temporal computations may be performed by using convolution neural networks (CNN) or Long Short-Term Memory (LSTM) neural networks. For example, after the graphs Xₜ₋ₙ, . . . , Xₜ₋₁, Xₜ are updated (e.g., the feature vectors of the nodes are updated through a GNN), the temporal computations may be performed on the updated graphs to learn the evolving trends of the vertices and/or edges in the updated graphs. CNN or LSTM may be used to receive the graphs as input and output the prediction 340 for the next timestep, denoted as Xₜ₊₁.

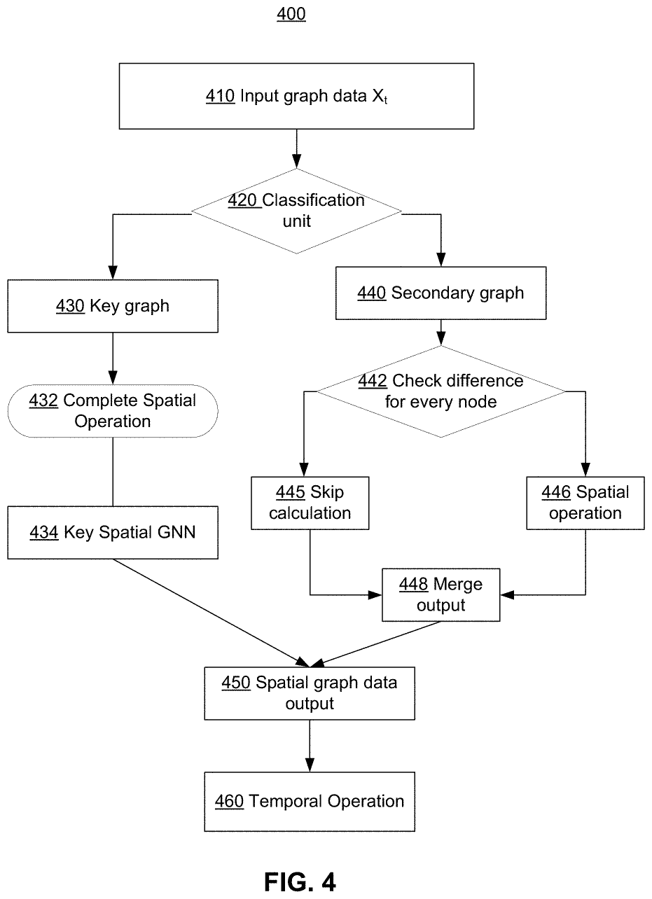

FIG. 4 illustrates an exemplary workflow 400 for accelerating temporal GNN computations with deduplication in accordance with some embodiments. The workflow 400 is for illustrative purposes only. It may be implemented in the hardware environment illustrated in FIG. 1, by the hardware device illustrated in FIG. 2, and to improve the computation performance and energy efficiency of the temporal GNN computations illustrated in FIG. 3. Depending on the implementation, it may include fewer, more, or alternative steps. Some of the steps may be split or merged, and performed in different orders or parallel. The workflow 400 demonstrates how deduplication improves the efficiency of the spatial computations in a temporal GNN.

The temporal GNN may be used to explore both the spatial and temporal features among a plurality of snapshots of objects (e.g., the features/states of the objects) at different timesteps. These snapshots may be represented in graph data structures. Each object may refer to, for example, a vehicle or an intersection in the context of traffic control, a user or an organization in the context of social networks, or an ion or atom in the context of nano-scale molecules for learning about existing molecular structures as well as discovering new chemical structures. For example, the objects may refer to one or more geographic locations and the features/states of the objects at one timestep may include traffic images captured from the one or more geographic locations at the one timestep.

In some embodiments, one graph collected from one timestep may be selected as a key graph, and the other graphs may be treated as derivative versions of the key graph, also referred to as secondary graphs. All of the vertices in the key graph may go through the spatial computations, but only a subset of the vertices in the secondary graphs may need to be processed. As explained above, since the plurality of graphs may be collected from a plurality of consecutive time steps, the changes between the graphs of two adjacent time steps may be limited to a small number of vertices and/or edges. That is, the graphs may include a large amount of duplicate data that may be skipped in computation to accelerate the spatial computations. For example, after the key graph goes through the complete spatial computation, a next (secondary) graph sharing one or more vertices with the key graph may only need to perform spatial computations on the updated vertices. This way, the computation cost of performing spatial computations on the secondary graph and the amount of data to be cached/processed by the processors may be significantly reduced.

In some embodiments, the key graph may be determined in various ways. For example, the graph collected from the earliest timestep may be determined as the key graph. As another example, the key graph may be selected from a plurality of graphs that have been received by: for each of the plurality of graphs, determining an overall graph distance based on each graph distance between the graph and each of the other graphs; and determining the graph with a least overall graph distance as the first graph. The graph distances may be determined using various techniques such as edit distance/graph isomorphism, feature extraction, and iterative methods.

Referring to the workflow 400 in FIG. 4, the first step may include receiving an input graph data denoted as Xₜ at step 410, where t refers to the timestamp t. A classification unit may then be used to classify whether Xₜ is the key graph or a secondary graph at step 420. If Xₜ is the key graph 430, a complete set of spatial computations may be performed on all of the nodes in Xₜ at step 432. The spatial computations may generate an updated version of Xₜ, denoted as a key spatial GNN, at step 434. This key spatial GNN may be output as a spatial graph data 450 after the spatial computations are performed on the input graph data Xₜ. In some embodiments, the key spatial GNN may be stored in a buffer as an updated version of the key graph 430 for the next round of computation.

If Xₜ is a secondary graph, each node in the secondary graph 440 may be compared against the corresponding node in the key graph 430 (e.g., an updated key graph from the previous timestep) at step 442. In some embodiments, the comparison at step 442 may include determining a distance between each node in the secondary graph 440 and the corresponding node in the key graph 430. The distance may refer to a feature vector distance determined by, for example, a Hamming distance between the feature vectors of the two nodes. In some embodiments, the comparison at step 442 may include identifying one or more nodes of the secondary graph 440 that do not exist in the key graph 430.

In some embodiments, if the distance between the two nodes is smaller than a threshold, the node in the secondary graph 440 may skip the spatial computations at step 445. If the distance between the two nodes is greater than a threshold, the node in the secondary graph 440 may be identified as “changed” and thus go through the spatial computations at step 446. This way, the efficiency of the spatial computations may be improved by skipping the duplicated or un-changed nodes in the secondary graph 440. In some embodiments, the threshold may determine the tradeoff between accuracy and the efficiency improvement of the spatial computations. For example, a higher threshold may lead to a smaller number of nodes in the secondary graph 440 to be identified as “changed” and processed (e.g., extracting spatial features), which may lead to lower accuracy in the output graph but a faster processing speed. Therefore, the threshold may be determined by machine learning algorithms to find the optimal tradeoff balance.

In some embodiments, the spatial computations may also be referred to as GNN computations, which may include: obtaining a feature vector of a node (e.g., a node from the secondary graph 440) and an adjacency matrix of a graph to which the node belongs to (e.g., the secondary graph 440); identifying neighboring nodes of the node in the graph based on the adjacency matrix; recursively aggregating and transforming feature vectors of the neighboring nodes and the feature vector of the node; and obtaining an updated feature vector of the node.

After the “changed” nodes in the secondary graph 440 going through the GNN computations, their feature vectors may be updated. In some embodiments, these “changed” nodes (with updated feature vectors) and the other “unchanged” nodes (with original feature vectors, also referred to as skipped nodes) may be then merged as an output secondary graph at step 448. In order to generate the updated feature vectors for all the nodes in the secondary graph 440, the “unchanged” nodes in the secondary graph 440 may directly adopt the updated feature vectors of the corresponding nodes in the key graph 430 without going through the GNN computations. This way, all the nodes in the secondary graph 440 may be merged as the spatial graph output 450. For instance, the spatial graph output 450 (e.g., the updated secondary graph) may be obtained by inserting the updated nodes into the key graph 430. The process may include identifying, in the key graph 430, one or more first nodes that correspond to the one or more updated nodes; and generating the spatial graph data output 450 by replacing feature vectors of the one or more first nodes with feature vectors of the one or more updated nodes.

This spatial graph output 450 may be deemed as the output of the spatial computations performed on the input graph data Xₜ. In some embodiments, the “unchanged” nodes may update their feature vectors based on the corresponding nodes in the key graph 430 before the spatial computations are performed on the “changed” nodes at step 446. By doing so, if a “changed” node in the secondary graph 440 has a plurality of “unchanged” nodes as neighbors, the feature updates to the “changed” node may be based on the updated feature vectors of its neighboring nodes. Here, the “unchanged” does not necessarily mean “same.” In certain cases, a distance between two feature vectors within a threshold may indicate the two corresponding nodes are “unchanged.” Therefore, using the updated features of “unchanged” nodes can improve the accuracy of the spatial computations.

After the spatial graph outputs 450 are generated for multiple input graph data such as Xₜ₋₁ and Xₜ, temporal computations may be performed to explore the temporal features. In some embodiments, the temporal computations may include training a temporal neural network based on a first updated graph (e.g., the spatial graph data output 450 based on Xₜ₋₁ at timestep t−1) and a second updated graph (e.g., the spatial graph data output 450 based on Xₜ at timestep t); and generating, based on the temporal neural network, a predicted graph representing the state of the one or more objects at the next timestep. In some embodiments, the temporal neural network may be a convolutional neural network (CNN) or Long Short-Term Memory (LSTM) neural network. In some embodiments, the spatial graph data output 450 at two consecutive timesteps may be referred to as two updated key graphs that may go through temporal operations. A rolling buffer may store the two most recently updated key graphs for performing temporal operations. When a new version of the key graph is computed via the spatial operations, it will replace the older version in the rolling buffer.

In some embodiments, the temporal computations at step 460 may also be accelerated based on deduplication. For example, rather than training the temporal neural network based on two complete updated key graphs from Xₜ₋₁ and Xₜ, the training may be based on a first updated key graph (e.g., the spatial graph data output for Xₜ₋₁) and the “changed” nodes in the second updated key graph (e.g., the changed nodes in Xₜ).

In some embodiments, the key graph 430 may be updated after each secondary graph 440 goes through the spatial computations. For example, it is assumed that the graph Xₜ₋ₙ is selected as the key graph 430. After the secondary graph Xₜ₋ₙ₊₁ goes through the spatial computations based on the key graph 430, an updated secondary graph Xₜ₋ₙ₊₁′ may be generated. The key graph 430 may be updated as Xₜ₋ₙ₊₁′ before the graph Xₜ₋ₙ₊₂ is processed.

Spatial GNN computations involve an iterative process. The workflow 400 illustrates steps of one round of the iterative process. The spatial graph data output 450 (an updated key graph) may be cached for the next round of temporal GNN computation against a newly received secondary graph.

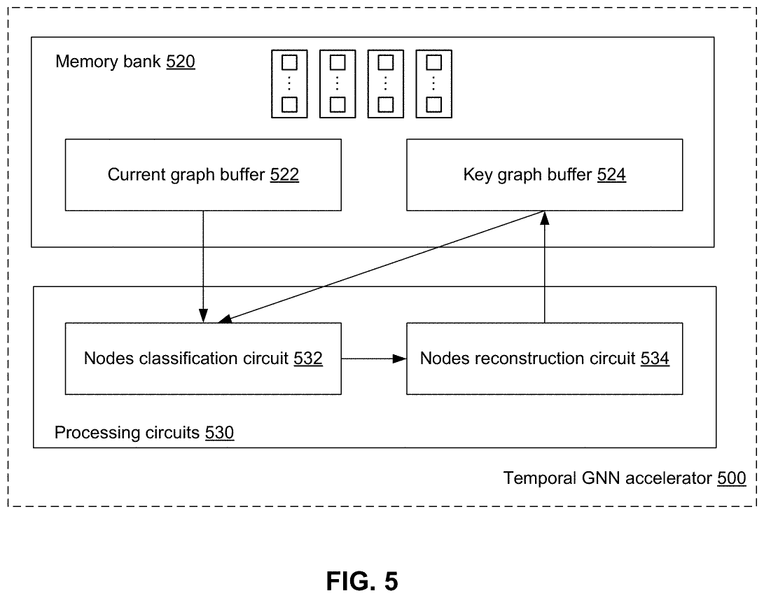

FIG. 5 illustrates an internal structure diagram 500 of a temporal GNN accelerator in accordance with some embodiments. The temporal GNN accelerator 500 in FIG. 5 is for illustrative purposes only, and may include fewer, more, or alternative components/data communication channels depending on the implementation. For example, the memory bank 520 in FIG. 5 may be implemented as an on-chip memory (inside of the temporal GNN accelerator 500) or an off-chip memory (outside of the temporal GNN accelerator 500). The temporal GNN accelerator 500 illustrates the data exchange between two hardware layers, the memory bank 520 (on-chip or off-chip) implemented with any type of transient or non-transient computer memory and processing circuits 530 configured to perform spatial computations using GNN and temporal computations using CNN or LSTM.

As described in FIGS. 3 and 4, the input to a temporal GNN may include a series of input data collected from a series of time steps. The input data at a time step may include features of a plurality of objects at that time step, which are represented as a graph. The output of the temporal GNN may include a prediction (e.g., predicted features of the objects at the next time step). In some embodiments, the series of graphs may be fed into the memory bank 520 sequentially. One of the series of graphs may be selected as a key graph. Nodes in the key graph may go through a complete set of spatial computations to obtain an updated key graph. The other graphs, referred to as secondary graphs, may compare against the key graph. The “changed” nodes in the secondary graphs may go through the spatial computations and the “unchanged” (also called duplicated) nodes may skip the computing-intensive spatial computations.

In some embodiments, the memory bank 520 in FIG. 5 may receive the series of input data represented in graphs from another storage medium (such as persistent storage) or directly from input devices (such as cameras). The memory bank 520 may include a key graph buffer 524 (e.g., a first memory) and a current graph buffer 522 (e.g., a second memory). The current graph buffer 522 may be configured to store a newly received input graph data, and the key graph buffer 524 may be configured to store the most recently updated key graph. For example, when a first graph collected from the earliest time step is received by the memory bank 520, it may be selected as the key graph and stored in the key graph buffer 524. Subsequently, it may be sent to the processing circuits 530 to perform a complete set of spatial computations to generate an updated key graph. This updated key graph may be sent back to the memory bank and stored in the key graph buffer 524 for the next round of processing.

When a second graph is received by the memory bank 520, it may be stored in the current graph buffer 522. Then the second graph in the current graph buffer 522 and the updated key graph in the key graph buffer 524 may be both sent to the processing circuits 530 for processing. In some embodiments, the second graph and the updated key graph may be first sent to a nodes classification circuit 532 to determine which nodes or which portions of the nodes in the second graph need to go through spatial computations. The nodes classification circuit 532 may be implemented by a hardware circuit, called nodes classification circuit. For example, if a Hamming distance between a node in the second graph and the corresponding node in the updated key graph is greater than a threshold, the node in the second graph may be selected to go through the spatial computation. As a data structure in the realm of computer technologies, each node in a graph may be represented as a feature vector. The feature vector may include one or more values of various data types. The values may be internally stored as a sequence of bits in a computer. For example, a value of 32-bit floating number may include a first bit as the sign bit, the next 8 bits as exponent bits, and the rest 23 bits as fraction bits. As another example, a value of 64-bit floating number may include a first bit as the sign bit, the next 11 bits as exponent bits, and the rest 52 bits as fraction bits. Comparing a node in the second graph and a corresponding node in the updated key graph may include determining a unit of bits to be compared between the first feature vector of a node and the second feature vector of the other node based on a type of data within the first feature vector and the second feature vector; for each unit of bits within the first feature vector, comparing exponent bits and one or more fraction bits within the each unit of bits against corresponding bits within the second feature vector to obtain a number of matching bits; and determining the distance between the first feature vector and the second feature vector based on the number of matching bits.

In some embodiments, the one or more nodes identified as over-the-threshold (e.g., with distances to the corresponding nodes in the updated key graph being greater than the threshold) in the secondary graph may be sent to a nodes reconstruction circuit 534 for performing spatial computations. The nodes reconstruction circuit 534 may be implemented by a hardware circuit, called nodes reconstruction circuit. The other nodes in the second graph may skip the spatial computation, but may be updated by directly copying from the feature vectors of the corresponding nodes in the updated key graph. Subsequently, the over-the-threshold nodes and the skipped nodes may be merged to generate a new key graph. This new key graph may be sent back to the memory bank and stored in the key graph buffer for the next round of processing.

The next round of processing may start with reading a third graph from the plurality of graphs and replacing the second graph in the current graph buffer 522. One or more nodes of the third graph may be identified based on comparing the third graph against the new key graph stored in the key graph buffer. The comparison may be based on Hamming distances between corresponding nodes and/or whether a node in the third graph is a new node (e.g., does not exist in the new key graph). The one or more nodes may then be updated through GNN computations (e.g., the spatial computations) to obtain one or more updated feature vectors. These updated feature vectors and the new key graph may be merged to construct an updated third graph. In some embodiments, the merge step may occur before or after performing the GNN computations on the identified nodes. The newly generated updated third graph may be sent to the key graph buffer for storage and become the most recently updated key graph for the next round of computation.

In some embodiments, at least the two most recent versions of the key graph may be stored in the key graph buffer. Temporal computations may be performed to explore the temporal features among the stored key graphs. The temporal computations may be performed by a hardware circuit, called temporal computations circuit (not shown in FIG. 5) within the processing circuits 530. In some embodiments, the temporal computations may include using a trained convolutional neural network (CNN) or a Long Short-Term Memory neural network to learn the temporal features and make predictions (predicting the graphs) for future time steps. In some embodiments, the key graph buffer may be a FIFO memory that keeps the two most recently updated key graphs. When a new updated key graph is generated, the relatively older version of the two in the key graph buffer may be replaced by the new updated key graph.

In some embodiments, the above-mentioned circuits may be implemented in various hardware forms, such as a Central Processing Unit (CPU), a Graphic Processing Unit (GPU), application-specific integrated circuit (ASIC), field programmable gate array (FPGA), or other suitable forms.

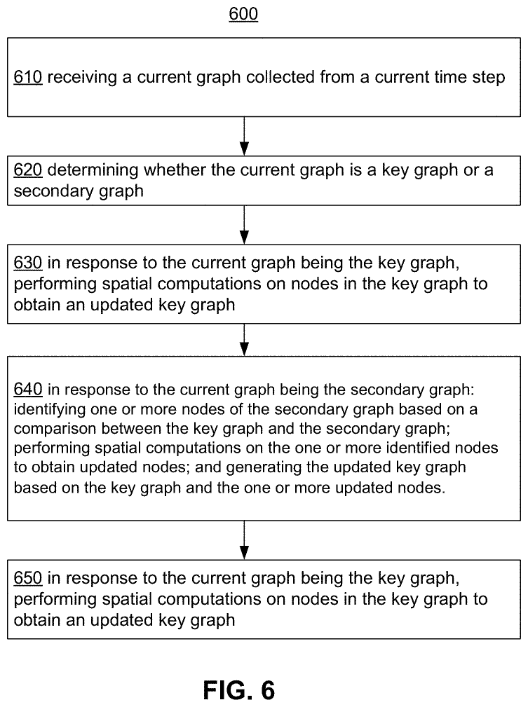

FIG. 6 illustrates an exemplary method 600 for accelerating temporal GNN computations with deduplication in accordance with some embodiments. The method 600 may be implemented in a hardware environment shown in FIG. 1. The method 600 may be performed by a device, apparatus, or system illustrated by FIGS. 2-5. Depending on the implementation, the method 600 may include additional, fewer, or alternative steps performed in various orders or parallel.

Block 610 includes receiving a current graph collected from a current time step.

Block 620 includes determining whether the current graph is a key graph or a secondary graph. In some embodiments, the determining whether the current graph is a key graph or a secondary graph comprises: determining the current graph is the key graph if it is a first received graph.

Block 630 includes in response to the current graph being the key graph, performing spatial computations on nodes in the key graph to obtain an updated key graph.

Block 640 includes in response to the current graph being the secondary graph: identifying one or more nodes of the secondary graph based on a comparison between the key graph and the secondary graph; performing spatial computations on the one or more identified nodes to obtain updated nodes; and generating the updated key graph based on the key graph and the one or more updated nodes. In some embodiments, the identifying the one or more nodes of the secondary graph include for each node in the secondary graph, identifying a corresponding node in the key graph; determine a distance between a first feature vector of the node in the secondary graph and a second feature vector of the corresponding node in the key graph; and select the node if the distance is greater than a threshold.

Block 650 includes performing temporal computations based on the key graph and the updated key graph to predict a graph at a future time step. In some embodiments, the temporal computations comprise determining temporal features between the key graph and the updated key graph with a convolutional neural network (CNN) or a Long Short-Term Memory (LSTM) neural network.

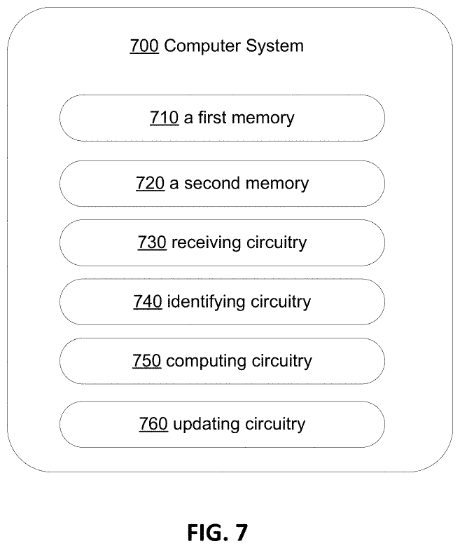

FIG. 7 illustrates a block diagram of a computer system 700 for accelerating temporal GNN in accordance with some embodiments. The components of the computer system 700 presented below are intended to be illustrative. Depending on the implementation, the computer system 700 may include additional, fewer, or alternative components. The computer system 700 may be the embodiment of the hardware device(s) illustrated in FIGS. 1-2 and may implement the methods or workflows illustrated in FIGS. 3-6.

The computer system 700 may include various circuitry, for example, implemented with one or more processors, and one or more non-transitory computer-readable storage media (e.g., one or more memories) coupled to the one or more processors and configured with instructions executable by the one or more processors to cause the system or device (e.g., the processor) to perform the above-described embodiments. The computer system 700 may include various units/modules corresponding to the instructions (e.g., software instructions).

In some embodiments, the computer system 700 may include a first memory 710, a second memory 720, receiving circuitry 730, identifying circuitry 740, and computing circuitry 750, and updating circuitry 760. In some embodiments, the first memory 710 may be configured to store a most recently updated key graph. The second memory 720 may be configured to store a current graph for spatial GNN computation. The first memory 710 and the second memory 720 may be implemented within a same computer memory at different addresses, or as two separate memories.

In some embodiments, the receiving circuitry 730 may be configured to receive the key graph from the first memory 710 and the current graph from the second memory 720. The identifying circuitry 740 may be configured to identify one or more nodes of the current graph based on a comparison between the key graph and the current graph. The computing circuitry 750 may be configured perform spatial computations on the one or more identified nodes to obtain updated nodes. The updating circuitry 760 may be configured generate an updated key graph based on the key graph and the updated nodes for the first memory to store the updated key graph for the temporal GNN computation. In some embodiments, the above-illustrated circuitries may be implemented within a same processor or by a plurality of processors. The circuitries and the memories may be implemented within a same hardware accelerator or as different hardware devices.

In some embodiments, the computer system 700 may further include computing circuitry configured to perform temporal computations based on the key graph and the updated key graph, i.e., two consecutive versions of key graphs, to learn the temporal features/trends across different the key graphs and predict key graphs for further steps.

The performance of certain of the operations described in this disclosure may be distributed among the processors, not only residing within a single device, but deployed across a number of devices. In some example embodiments, the processors or processor-implemented circuitry may be located in a single die or different dies. In other example embodiments, the processors or processor-implemented engines may be distributed across a number of geographic locations.

Each of the processes, methods, and algorithms described in the preceding sections may be embodied in, and fully or partially automated by, code modules executed by one or more computer systems or computer processors comprising computer hardware. The processes and algorithms may be implemented partially or wholly in application-specific circuitry.

When the functions disclosed herein are implemented in the form of software functional units and sold or used as independent products, they can be stored in a processor executable non-volatile computer-readable storage medium. Particular technical solutions disclosed herein (in whole or in part) or aspects that contribute to current technologies may be embodied in the form of a software product. The software product may be stored in a storage medium, comprising a number of instructions to cause a computing device (which may be a personal computer, a server, a network device, and the like) to execute all or some steps of the methods of the embodiments of the present application. The storage medium may comprise a flash drive, a portable hard drive, ROM, RAM, a magnetic disk, an optical disc, another medium operable to store program code, or any combination thereof.

Particular embodiments further provide a system comprising a processor and a non-transitory computer-readable storage medium storing instructions executable by the processor to cause the system to perform operations corresponding to steps in any method of the embodiments disclosed above. Particular embodiments further provide a non-transitory computer-readable storage medium configured with instructions executable by one or more processors to cause the one or more processors to perform operations corresponding to steps in any method of the embodiments disclosed above.

The various features and processes described above may be used independently of one another or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner Blocks or states may be added to or removed from the disclosed example embodiments. The exemplary systems and components described herein may be configured differently than described. For example, elements may be added to, removed from, or rearranged compared to the disclosed example embodiments.

The various operations of example methods described herein may be performed, at least partially, by an algorithm. The algorithm may be comprised in program codes or instructions stored in a memory (e.g., a non-transitory computer-readable storage medium described above). Such algorithm may comprise a machine learning algorithm. In some embodiments, a machine learning algorithm may not explicitly program computers to perform a function but can learn from training data to make a prediction model that performs the function.

The various operations of example methods described herein may be performed, at least partially, by one or more processors that are temporarily configured (e.g., by software) or permanently configured to perform the relevant operations. Whether temporarily or permanently configured, such processors may constitute processor-implemented engines that operate to perform one or more operations or functions described herein.

Similarly, the methods described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the subject matter has been described with reference to specific example embodiments, various modifications and changes may be made to these embodiments without departing from the broader scope of embodiments of the present disclosure. Such embodiments of the subject matter may be referred to herein, individually or collectively, by the term “invention” merely for convenience and without intending to voluntarily limit the scope of this application to any single disclosure or concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Any process descriptions, elements, or blocks in the flow diagrams described herein and/or depicted in the attached figures should be understood as potentially representing modules, segments, or sections of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

As used herein, “or” is inclusive and not exclusive, unless expressly indicated otherwise or indicated otherwise by context. Therefore, herein, “A, B, or C” means “A, B, A and B, A and C, B and C, or A, B, and C,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context. Moreover, plural instances may be provided for resources, operations, or structures described herein as a single instance. Additionally, boundaries between various resources, operations, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The term “include” or “comprise” is used to indicate the existence of the subsequently declared features, but it does not exclude the addition of other features. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

What is claimed is:

1. A hardware accelerator for accelerating temporal graphic neural network (GNN) computations, comprising:
a key-graph memory configured to store a key graph;
a nodes classification circuit configured to:
fetch the key graph from the key-graph memory;
receive a current graph for performing temporal GNN computation with the key graph; and
identify one or more nodes of the current graph based on a comparison between the key graph and the current graph; and
a nodes reconstruction circuit configured to:
perform spatial computations on the one or more nodes identified by the node classification circuit to obtain updated nodes;
generate an updated key graph based on the key graph and the updated nodes; and
store the updated key graph in the key-graph memory for processing a next graph.

2. The computer system of claim 1, wherein to identify the one or more nodes of the current graph, the nodes classification circuit is configured to:
for each node in the current graph, identify a corresponding node in the key graph;
determine a distance between a first feature vector of the node in the current graph and a second feature vector of the corresponding node in the key graph; and
select the node if the distance is greater than a threshold.

3. The computer system of claim 2, wherein the distance is a Hamming distance.

4. The computer system of claim 2, wherein to determine the distance between the first feature vector of the node in the current graph and the second feature vector of the corresponding node in the key graph, the nodes classification circuit is configured to:
determine a unit of bits to be compared between the first feature vector and the second feature vector based on a type of data within the first feature vector and the second feature vector;
for each unit of bits within the first feature vector, compare exponent bits and one or more fraction bits within the each unit of bits against corresponding bits within the second feature vector to obtain a number of matching bits; and
determine the distance between the first feature vector and the second feature vector based on the number of matching bits.

5. The computer system of claim 1, wherein the nodes classification circuit is further configured to:
in response to the key graph received from the key-graph memory being empty, sending the received current graph to the nodes reconstruction circuit; and
wherein the nodes reconstruction circuit is further configured to:
perform spatial computations on each node in the current graph to obtain a new key graph, wherein the spatial computations comprise GNN computations; and
send the new key graph to the key-graph memory for storing.

6. The computer system of claim 1, wherein to perform the spatial computations on the one or more identified nodes, the nodes reconstruction circuit is further configured to:
obtain a feature vector of one node from the one or more identified nodes and an adjacency matrix of the current graph;
identify one or more neighboring nodes based on the adjacency matrix;
recursively aggregate and transform feature vectors of the one or more neighboring nodes and the feature vector of the node to obtain the updated feature vector of the node.

7. The computer system of claim 1, further comprising:
a temporal computation circuit configured to perform temporal computations based on the key graph and the updated key graph.

8. The computer system of claim 7, wherein the temporal computations comprise:
determining temporal features between the key graph and the updated key graph with a convolutional neural network (CNN).

9. The computer system of claim 7, wherein the temporal computations comprise:
determining temporal features between the key graph and the updated key graph with a Long Short-Term Memory (LSTM) neural network.

10. The computer system of claim 1, wherein to generate the updated key graph based on the key graph and the updated nodes, the nodes reconstruction circuit is configured to:
identify, in the key graph, one or more first nodes that correspond to the one or more updated nodes; and generate the updated key graph by replacing feature vectors of the one or more first nodes in the key graph with feature vectors of the one or more updated nodes.

11. A computer system for accelerating temporal graph neural network (Temporal GNN) computations, comprising:
a first memory configured to store a key graph;
a second memory configured to store a current graph for temporal GNN computation;
receiving circuitry configured to receive the key graph from the first memory and the current graph from the second memory;
identifying circuitry configured to identify one or more nodes of the current graph based on a comparison between the key graph and the current graph;
computing circuitry configured to perform spatial computations on the one or more identified nodes to obtain updated nodes; and
updating circuitry configured to generate an updated key graph based on the key graph and the updated nodes for the first memory to store the updated key graph for the temporal GNN computation.

12. The computer system of claim 11, wherein to identify the one or more nodes of the current graph, the identifying circuitry is configured to:
for each node in the current graph, identify a corresponding node in the key graph;
determine a distance between a first feature vector of the node in the current graph and a second feature vector of the corresponding node in the key graph; and
select the node if the distance is greater than a threshold.

13. The computer system of claim 12, wherein to determine the distance between the first feature vector of the node in the current graph and the second feature vector of the corresponding node in the key graph, the identifying circuitry is configured to:
determine a unit of bits to be compared between the first feature vector and the second feature vector based on a type of data within the first feature vector and the second feature vector;
for each unit of bits within the first feature vector, compare exponent bits and one or more fraction bits within the each unit of bits against corresponding bits within the second feature vector to obtain a number of matching bits; and
determine the distance between the first feature vector and the second feature vector based on the number of matching bits.

14. The computer system of claim 11, wherein the identifying circuitry is further configured to:
in response to the key graph received from the first memory being empty, send the current graph received from the second memory to the first memory as a new key graph.

15. The computer system of claim 11, wherein the identifying circuitry is further configured to:
in response to the key graph received from the first memory being empty, identify all nodes in the current graph; and
the computing circuitry is further configured to:
perform spatial computations on all nodes in the current graph to obtain the updated key graph.

16. The computer system of claim 11, wherein to perform the spatial computations on the one or more identified nodes, the computing circuitry is further configured to:
obtain a feature vector of one node from the one or more identified nodes and an adjacency matrix of the current graph;
identify one or more neighboring nodes based on the adjacency matrix;
recursively aggregate and transform feature vectors of the one or more neighboring nodes and the feature vector of the node to obtain the updated feature vector of the node.

17. The computer system of claim 11, further comprising:
second computing circuitry configured to perform temporal computations based on the key graph and the updated key graph.

18. A computer-implemented method for accelerating temporal graphic neural network (GNN) computations, comprising:
receiving a current graph collected from a current time step;
determining whether the current graph is a key graph or a secondary graph;
in response to the current graph being the key graph, performing spatial computations on nodes in the key graph to obtain an updated key graph;
in response to the current graph being the secondary graph:
identifying one or more nodes of the secondary graph based on a comparison between the key graph and the secondary graph;
performing spatial computations on the one or more identified nodes to obtain updated nodes; and
generating the updated key graph based on the key graph and the one or more updated nodes; and
performing temporal computations based on the key graph and the updated key graph to predict a graph at a future time step.

19. The method of claim 18, wherein the determining whether the current graph is a key graph or a secondary graph comprises:
determining the current graph is the key graph if it is a first received graph.

20. The method of claim 18, wherein the temporal computations comprise:
determining temporal features between the key graph and the updated key graph with a convolutional neural network (CNN) or a Long Short-Term Memory (LSTM) neural network.
